(19) United States
(12) Patent Application Publication
(10) Pub. No.: US 2014/0094309 A1
(43) Pub. Date: Apr. 3, 2014

(54) CONTROLLER DEVICE

(71) Applicant: Sony Computer Entertainment Inc., Tokyo (JP)

(72) Inventors: Hiroshi Osawa, Kanagawa (JP); Takeshi Yamagishi, Kanagawa (JP)

(21) Appl. No.: 14/117,913

(22) PCT Filed: May 24, 2012
(86) PCT No.: PCT/JP2012/063355

§ 371 Date: Nov. 15, 2013

(30) Foreign Application Priority Data
Jun. 6, 2011 (JP) 2011-126038
Jun. 6, 2011 (JP) 2011-126039

(51) Int. Cl. A63F 13/20

(52) U.S. Cl. CPC A63F 13/06
USPC 463/37

(57) ABSTRACT

Provided is a controller device capable of performing various operation inputs to an information processor via an attachment despite the attachment not being provided with an electrical circuit. The controller device includes a core unit having a touch sensor disposed on a surface thereof, and an attachment that is attached to the core unit so as to cover the touch sensor. The attachment is provided with an operation member that is configured so as to be able to contact the touch sensor in a state where the attachment is attached to the core unit, the contact mode with respect to the touch sensor changing in accordance with user operation.

### TECHNICAL FIELD

The present invention relates to a controller device for making an operation input to an information processor, a core unit making up the controller device and an information processing system including the controller device.

### BACKGROUND ART

There are controller devices used, for example, to make a variety of operation inputs to an information processor such as home gaming machine. Such controller devices must have a variety of operating members such as buttons and analog stick to suit the nature of application program executed by the information processor to be operated. However, incorporating all of such a variety of operating members leads to a large controller device, making it inconvenient to handle and resulting in an expensive device. Therefore, a controller device has been proposed which can be expanded by fitting an attachment having a specific operating member to the controller device main body (core unit) as necessary. Such a controller device allows the user to add a variety of operating members by changing attachments in response to his or her needs, thus providing a variety of types of operation inputs.

### SUMMARY

However, each of the expansion attachments described above must have electrical circuitry to transmit the nature of user operation performed on its operating member to the core unit or information processor. As a result, it is necessary to supply power to each of the attachments using a battery or other means, thus resulting in time and effort for replacing or charging the battery.

Further, although attachments having a variety of operating members can be added to the above expandable controller device, if an attachment can be fitted only in a specific orientation, then the user can operate the expanded operating member always in the same orientation, thus resulting in a low degree of freedom.

The present invention has been devised in light of the foregoing, and it is an object of the present invention to provide a controller device capable of making a variety of operation inputs to an information processor via an attachment without the attachment having any electrical circuitry.

Further, it is another object of the present invention to provide a controller device that permits expansion with a higher degree of freedom, a core unit making up the controller device and an information processing system including the controller device.

A controller device according to a mode of the present invention includes a core unit and attachment. The core unit has a touch sensor arranged on one face thereof. The attachment is fitted to the core unit in such a manner as to cover the touch sensor. The attachment has an operating member that can come into contact with the touch sensor when fitted to the core unit. The manner in which the operating member comes into contact with the touch sensor changes in response to a user operation.

Further, a core unit according to the mode of the present invention is a core unit of a controller device used by fitting an attachment having an operating member. The core unit includes a touch sensor and fitting mechanism. The fitting mechanism is used to fit the attachment where at least part of the touch sensor is covered. The operating member can come into contact with the touch sensor with the attachment fitted to the core unit. The touch sensor detects the change in the manner in which the operating member comes into contact with the touch sensor in response to a user operation.

Still further, a controller device according to another mode of the present invention includes a core unit and first and second attachments. The core unit has first and second faces. The first attachment is fitted to the core unit in such a manner as to cover at least part of the first face. The second attachment is fitted to the core unit in such a manner as to cover at least part of the second face.

Still further, a core unit according to the another mode of the present invention is a core unit of a controller device used by fitting attachments. The core unit includes first and second faces and first and second fitting mechanisms. The first fitting mechanism is used to fit any one of a plurality types of first attachments where at least part of the first face is covered. The second fitting mechanism is used to fit any one of a plurality types of second attachments where at least part of the second face is covered.

Still further, an information processing system according to the present invention includes a controller device and information processor. The controller device includes a core unit and first and second attachments. The core unit has first and second faces. The first attachment is fitted to the core unit in such a manner as to cover at least part of the first face. The second attachment is fitted to the core unit in such a manner as to cover at least part of the second face. The information processor receives, from the controller device, an operation signal indicating the nature of user operation performed on the controller device, performing information processing in accordance with the received operation signal.

### BRIEF DESCRIPTION OF DRAWINGS

FIG. 1 is a general outline diagram of an information processing system including a controller device according to an embodiment of the present invention.

FIG. 2 is a perspective view of a core unit of the controller device according to the present embodiment as seen from the side of the front face.

FIG. 3 is a perspective view of the core unit as seen from the side of the back face.

FIG. 4 is a perspective view of a first button unit as seen from the side of the front face.

FIG. 5 is a perspective view of the first button unit as seen from the side of the back face.

FIG. 6 is a perspective view of a grip unit as seen from the side of the front face.

FIG. 7 is a perspective view of the grip unit as seen from the side of the back face.

FIG. 8 is a perspective view illustrating the controller device with the first button unit and grip unit fitted to the core unit.

FIG. 9 is a perspective view of a second button unit as seen from the side of the front face.

FIG. 10 is a perspective view of the second button unit as seen from the side of the back face.

FIG. 11 is a perspective view illustrating a three-dimensional operation input unit and auxiliary grip unit as seen from the side of the front face.

FIG. 12 is a perspective view illustrating the three-dimensional operation input unit and auxiliary grip unit as seen from the side of the back face.

FIG. 13 is a perspective view illustrating the controller device with the second button unit, three-dimensional operation input unit and auxiliary grip unit fitted to the core unit.

FIG. 14 is a perspective view illustrating the integral type three-dimensional operation input unit as seen from the side of the front face.

FIG. 15 is a perspective view illustrating the integral type three-dimensional operation input unit as seen from the side of the back face.

FIG. 16 is a perspective view illustrating a sphere unit as seen from the side of the front face.

FIG. 17 is a perspective view illustrating a sphere unit as seen from the side of the back face.

FIG. 18 is a perspective view illustrating the controller device with the sphere unit fitted to the core unit.

FIG. 19 is a perspective view illustrating an example of a pressing operation unit.

FIG. 20 is a sectional view of the pressing operation unit shown in FIG. 19.

FIG. 21 is a perspective view illustrating another example of the pressing operation unit.

FIG. 22 is a sectional view of the pressing operation unit shown in FIG. 21.

FIG. 23 is a perspective view illustrating the appearance of a throttle lever unit.

FIG. 24 is a sectional view illustrating an example of internal structure of the throttle lever unit.

FIG. 25 is a sectional view illustrating another example of internal structure of the throttle lever unit.

FIG. 26 is a sectional view of the throttle lever unit shown in FIG. 25.

FIG. 27 is a diagram illustrating an attachment having an operating member imitating a steering wheel.

FIG. 28 is a diagram illustrating an attachment having an operating member imitating a gear change lever.

FIG. 29 is a diagram illustrating an attachment having operating members imitating an accelerator pedal and brake pedal.

FIG. 30 is a diagram illustrating an attachment having an operating member imitating a keyboard.

FIG. 31 is a diagram illustrating an attachment having operating members imitating piston bubbles of a trumpet.

FIG. 32 is a diagram illustrating an attachment having an operating member imitating a drum.

FIG. 33 is a diagram illustrating an attachment having an operating member imitating a reel of a fishing rod.

FIG. 34 is a diagram illustrating an example of an attachment having a plurality of light-emitting sections.

FIG. 35 is a diagram illustrating another example of an attachment having a plurality of light-emitting sections.

FIG. 36 is a diagram illustrating an example of an attachment having markers.

FIG. 37 is a diagram illustrating an example of an attachment functioning as a remote controller for operating a household electric appliance.

FIG. 38 is a diagram illustrating an attachment in the form of a mat.

FIG. 39 is a diagram illustrating an example of a controller device to which an attachment having a touch sensor is fitted.

FIG. 40A is a perspective view illustrating an example of an operating member drive mechanism.

FIG. 40B is a diagram explaining how the operating member drive mechanism shown in FIG. 40A works.

FIG. 40C is a diagram explaining how the operating member drive mechanism shown in FIG. 40A works.

FIG. 41 is a perspective view illustrating another example of an operating member drive mechanism.

FIG. 42 is a perspective view illustrating still another example of an operating member drive mechanism.

### DESCRIPTION OF EMBODIMENTS

A controller device according to an embodiment of the present invention includes a core unit and attachment. The core unit has a touch sensor arranged on one face thereof. The attachment is fitted to the core unit in such a manner as to cover the touch sensor. The attachment has an operating member that can come into contact with the touch sensor when fitted to the core unit. The manner in which the operating member comes into contact with the touch sensor changes in response to a user operation.

In the controller device, the contact position of the operating member with the touch sensor may move in response to a user operation in the direction parallel to the detection surface of the touch sensor.

Further, in the controller device, the operating member may have a planar operation region sized to match the detection surface of the touch sensor so that if the user presses any position of the operation region, the manner in which the operating member comes into contact with the position of the touch sensor matching the pressed position changes.

Still further, the operating member may be configured so that at least either the pressure applied to the touch sensor or the area of contact with the touch sensor changes in accordance with the intensity with which the operation region is pressed, and the touch sensor may detect at least either the pressure applied by the operating member to the detection surface or the area of contact of the operating member.

Still further, in the controller device, the operating member may be arranged to be in contact with the detection surface of the touch sensor with the attachment fitted to the core unit even while the user operation does not take place, and the attachment may further include a mechanism adapted to maintain the operating member away from the detection surface of the touch sensor until the fitting of the attachment to the core unit is complete and move the operating member to the position where the operating member comes into contact with the detection surface of the touch sensor when the fitting of the attachment to the core unit is complete.

A controller device according to another embodiment of the present invention includes a core unit and attachment. The core unit has a touch sensor arranged on one face thereof. The attachment is fitted to the core unit in such a manner as to cover the touch sensor. The attachment has an operating member that can come into contact with the touch sensor when fitted to the core unit. The manner in which the operating member comes into contact with the touch sensor changes in response to a user operation.

In the controller device, at least either the first or second attachment may include a gripping section gripped by the user with a hand.

Further, in the controller device, the second face may be opposed to the first face.

Still further, in the controller device, the core unit may further include a third face, and the controller device may further include a third attachment fitted to the core unit in such a manner as to cover at least part of the third face.

Still further, an information processing system according to an embodiment of the present invention includes a controller device and information processor. The controller device includes a core unit and first and second attachments. The core unit has first and second faces. The first attachment is fitted to the core unit in such a manner as to cover at least part of the first face. The second attachment is fitted to the core unit in such a manner as to cover at least part of the second face. The information processor receives, from the controller device, an operation signal indicating the nature of user operation performed on the controller device, performing information processing in accordance with the received operation signal.

In the information processing system, at least either the first or second attachment may include a gripping section gripped by the user with a hand, and the core unit may include a posture detection sensor, and the information processor may identify the orientation in which the user grips the gripping section using the detection result of the posture detection sensor.

Further, in the information processing system, the core unit may include means of acquiring identification information used to identify the types of the first and second attachments. The information processor may identify each of the first and second attachments using the identification information acquired by the core unit.

Still further, in the information processing system, a touch sensor may be provided on the first face. The first attachment may be fitted to the core unit in such a manner as to cover the touch sensor and include a contact member adapted to come into contact with a predetermined position of the touch sensor when the first attachment is fitted to the core unit. The information processor may identify the type of the first attachment using information about the position of the touch sensor with which the contact member comes into contact.

A detailed description will be given below of the embodiments of the present invention based on the accompanying drawings.

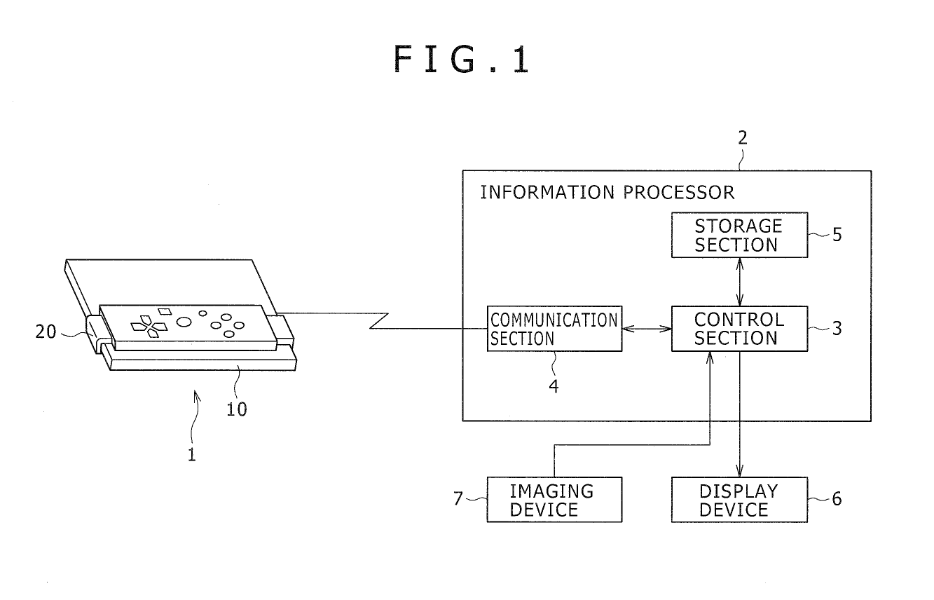

FIG. 1 is a general outline diagram of an information processing system including a controller device 1 according to an embodiment of the present invention. In the present embodiment, the information processing system includes the controller device 1 and an information processor 2 that are connected for communication via a wireless communication interface. The user grips the controller device 1 with his or her hands, making a variety of operation inputs to the operating member included in the controller device 1. The controller device 1 transmits a signal indicating the nature of user operation to the information processor 2 through wireless communication. The information processor 2 performs a variety of information processing tasks in accordance with the operation signal received from the controller device 1.

The controller device 1 includes a core unit 10 as the main body of the controller device 1, and a plurality of types of attachments that can be fitted to the core unit 10. It should be noted that FIG. 1 illustrates the controller device 1 with a first button unit 20 fitted to the core unit 10.

The information processor 2 is, for example, a home gaming machine and includes a control section 3, communication section 4 and storage section 5 and is connected to a display device 6 and imaging device 7.

The control section 3 is a program-controlled device such as CPU and performs a variety of information processing tasks in accordance with the program stored in the storage section 5. More specifically, for example, the control section 3 loads a game program from the storage section 5 and processes the game. The communication section 4 is a wireless communication interface such as Bluetooth (registered trademark), handling wireless communication with the core unit of the controller device 1.

The storage section 5 includes memory elements such as RAM and ROM, storing the program to be executed by the control section 3. Further, the storage section 5 functions as a work memory of the control section 3.

The display device 6 is, for example, a home television receiver, displaying an image indicating the result of processing performed by the information processor 2.

The imaging device 7 is, for example, a CCD camera that is installed, for example, on the top face of the display device 6 facing toward the user so as to capture an image of the controller device 1 gripped by the user with his or her hand. The information processor 2 analyzes the captured image, thus detecting the change in position and orientation of the controller device 1 in the space. In particular, if the user grips the controller device 1 with his or her hand and moves it with an attachment that can be optically detected with ease such as a sphere unit 80 which will be described later fitted thereto, the information processor 2 can detect such a motion of the controller device 1 using the image captured by the imaging device 7. The information processor 2 can acquire the motion of the controller device 1 as a kind of user operation input, handling information processing appropriate to the nature thereof.

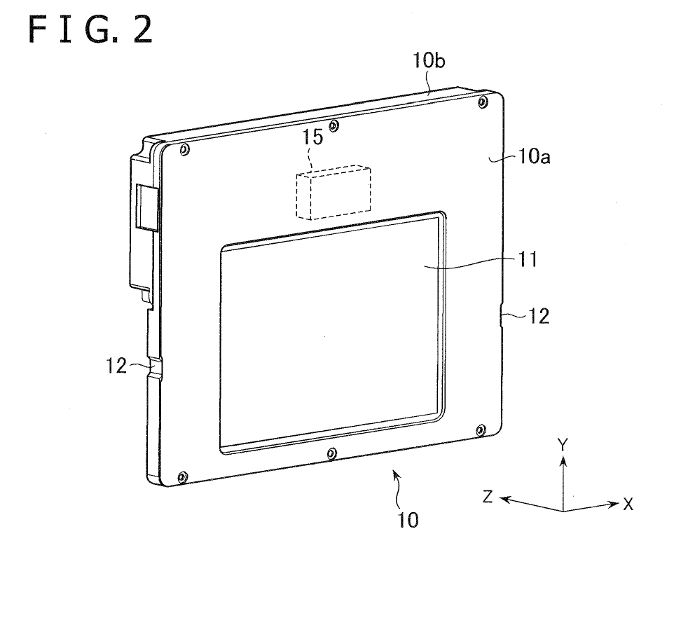

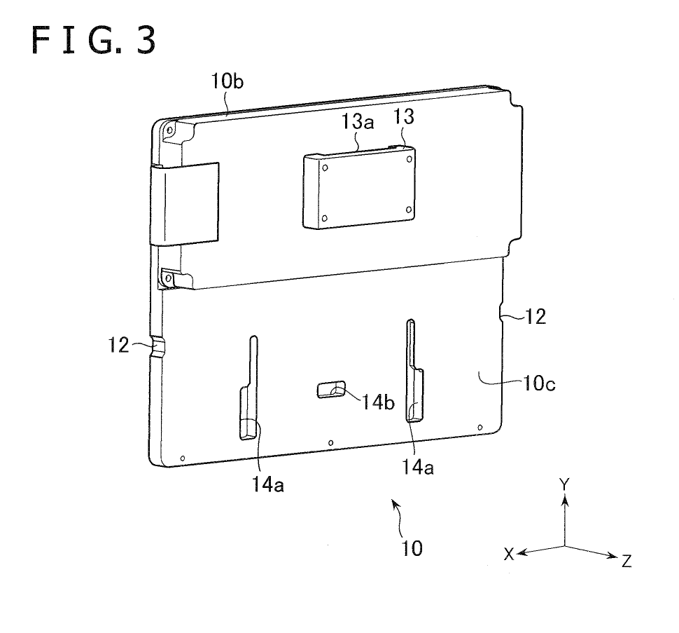

FIGS. 2 and 3 are perspective views illustrating the appearance of the core unit 10. FIG. 2 illustrates the core unit 10 as seen from the side of the front face, and FIG. 3 illustrates the core unit 10 as seen from the side of the back face. As illustrated in these figures, the core unit 10 is in the form of a thin plate, with a touch sensor 11 arranged on a front face 10a thereof. It should be noted that, in the description given below, the direction along the width of the core unit 10 (horizontal direction) will be denoted as the x-axis direction, the direction along the height thereof (vertical direction) as the y-axis direction, and the direction along the thickness thereof (longitudinal direction) as the z-axis direction.

The touch sensor 11 in the present embodiment is a multipoint detection sensor. That is, a plurality of detection regions are arranged over the approximately entire detection surface of the touch sensor 11 so that the touch sensor 11 detects whether or not any object comes into contact with any of these detection regions. This allows the touch sensor 11 to achieve detection of contact positions of a plurality of objects even if these objects such as a plurality of fingers of the user come into contact with the detection surface of the touch sensor 11 at the same time. Further, if a relatively large object comes into contact with the detection surface of the touch sensor 11, not only the position of the region of the detection surface with which the object has come into contact but also the size thereof (i.e., contact area) can be identified. Still further, the touch sensor 11 detects the magnitude of pressure applied to the detection surface by the object that has come into contact. That is, the touch sensor 11 can detect not only the contact position of an object but also the approximate intensity with which the object is pressed against the position.

A plurality of fitting mechanisms are arranged on the core unit 10 so that a plurality of different types of attachments are fitted by these fitting mechanisms at different positions. More specifically, grooves 12 are formed, one on each side face of the core unit 10, as a first fitting mechanism, and attachments that can be fitted to the grooves 12 are made available. The type of attachment that is fitted to the first fitting mechanism as described above will be hereinafter referred to as a front-fitted attachment. A front-fitted attachment is fitted to the core unit 10 in such a manner as to cover at least part of the touch sensor 11 arranged on the front face 10a (first face) of the core unit 10.

Further, two vertical holes 14a and a lug accommodating section 14b are arranged on a back face 10c of the core unit 10 as a second fitting mechanism. It should be noted that the lug accommodating section 14b is located at the approximate center of the core unit 10 in the x-axis direction whereas the two vertical holes 14a are arranged to extend on both sides of the lug accommodating section 14b in the y-axis direction. Still further, one end of both of the two vertical holes 14a is formed wide in the x-axis direction, with the other end thereof being less wide than the one end in the x-axis direction. The type of attachment that is fitted to this second fitting mechanism will be hereinafter referred to as a back-fitted attachment. A back-fitted attachment is fitted to the core unit 10 in such a manner as to cover at least part of the back face 10c (second face) of the core unit 10. Here, the front and back faces 10a and 10c are opposed to each other, thus allowing different attachments to be fitted on the front and back sides of the core unit 10. This makes it possible to fit an attachment having an operating member to be operated by the user to the front face of the core unit 10 and an attachment having a gripping section that permits easy gripping of the core unit 10 to the back face of the core unit 10 or fit different types of attachments to both faces, thus providing a high degree of freedom in expansion.

Further, a fitting section 13 having an insertion slot 13a is arranged away from the vertical holes 14a and lug accommodating section 14b on the back face 10c of the core unit 10 as a third fitting mechanism. This insertion slot 13a is open toward a side face 10b of the core unit 10. The type of attachment that is fitted to this third fitting mechanism will be hereinafter referred to as a side-fitted attachment. A side-fitted attachment is fitted to the core unit 10 in such a manner as to cover at least part of each of the back and side faces 10c and 10b (third face).

Still further, a posture detection sensor 15 is arranged inside the core unit 10 to detect the change in posture of the core unit 10. The posture detection sensor 15 may be, for example, an acceleration sensor adapted to detect the gravitational acceleration, a gyroscope adapted to detect the angular velocity of rotation, or a magnetic sensor adapted to detect the orientation of the geomagnetism. Alternatively, the posture detection sensor 15 may be a combination of the above sensors. The detection result of the posture detection sensor 15 is transmitted to the information processor 2 for use in processing performed by the information processor 2.

A description will be given below of specific examples of a variety of attachments fitted to the core unit 10.

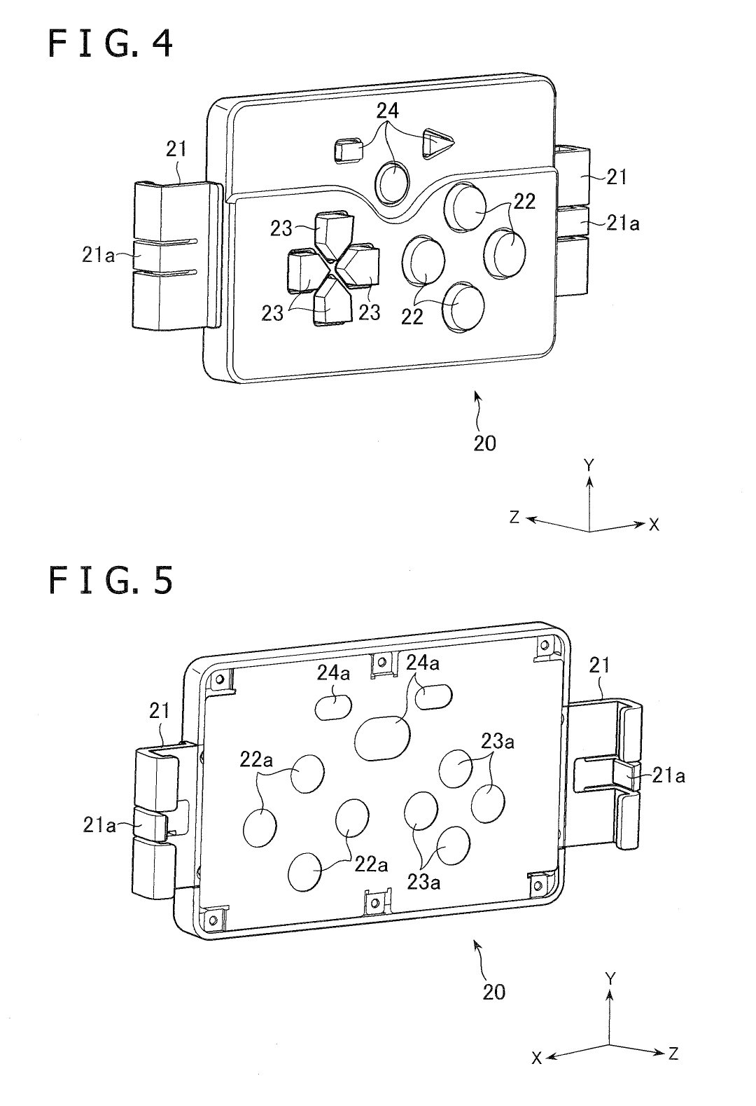

FIGS. 4 and 5 are perspective views illustrating the appearance of a first button unit 20, a specific example of a front-fitted attachment. More specifically, FIG. 4 illustrates the first button unit 20 as seen from the side of the front face, and FIG. 5 illustrates the first button unit 20 as seen from the side of the back face. It should be noted that, in the perspective views of the attachments including those which will follow, arrows are shown to represent the directions of the reference axes of the core unit 10 with the attachment fitted to the core unit 10 so as to indicate the direction in which the attachment is to be fitted to the core unit 10.

Holding sections 21 are provided, one on the left side face and another on the right side face of the first button unit 20, with a lug 21a provided approximately in the middle of each of the left and right holding sections 21. When the first button unit 20 is laid over the core unit 10 from the bottom face in such a manner that the holding sections 21 hold the side faces of the core unit 10, each of the lugs 21a engages with one of the grooves 12 provided on the side faces of the core unit 10, thus fastening the first button unit 20 to the core unit 10. At this time, the back face of the first button unit 20 is opposed to the front face 10a of the core unit 10, thus causing the first button unit 20 to cover part of the front face 10a of the core unit 10.

Four action buttons 22, four direction indicating buttons 23 and three function buttons 24 to be operated by the user are arranged on the front face of the first button unit 20. Each of these buttons extends to penetrate the first button unit 20 in the direction of depth, with the end portion thereof on the back face (i.e., the end portion opposite to that on the front face to be operated by the user) being exposed on the back face of the first button unit 20. More specifically, as illustrated in FIG. 5, lower ends 22a of the action buttons 22, lower ends 23a of the direction indicating buttons 23, and lower ends 24a of the function buttons 24, are all exposed on the back face of the first button unit 20. Then, these buttons are all located in the detection surface of the touch sensor 11 as seen from the side of the front face of the controller device 1 when the first button unit 20 is fitted to the core unit 10. Therefore, when the user presses each of the buttons in the z-axis direction, the lower end of the pressed button comes into contact with the detection surface of the touch sensor 11. That is, when the user presses one of the buttons, the touch sensor 11 detects the contact of the button, allowing the core unit 10 to transmit information indicating the contact position to the information processor 2. The information processor 2 identifies which button has been pressed by the user using the information about the position detected by the touch sensor 11. It should be noted that each button is biased toward the side of the front face, and that when the user removes the finger from the button, the button returns to its initial position, detaching itself from the touch sensor 11. That is, the lower end of each of the buttons is in contact with the touch sensor 11 only while the user presses the button.

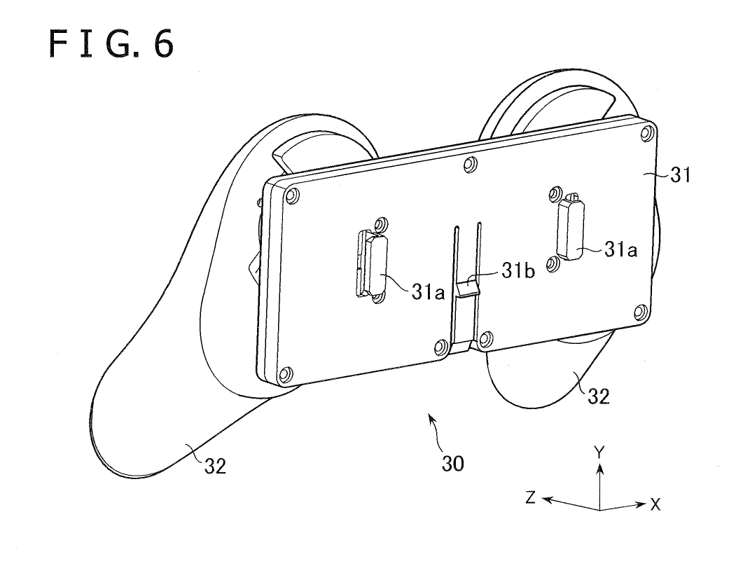

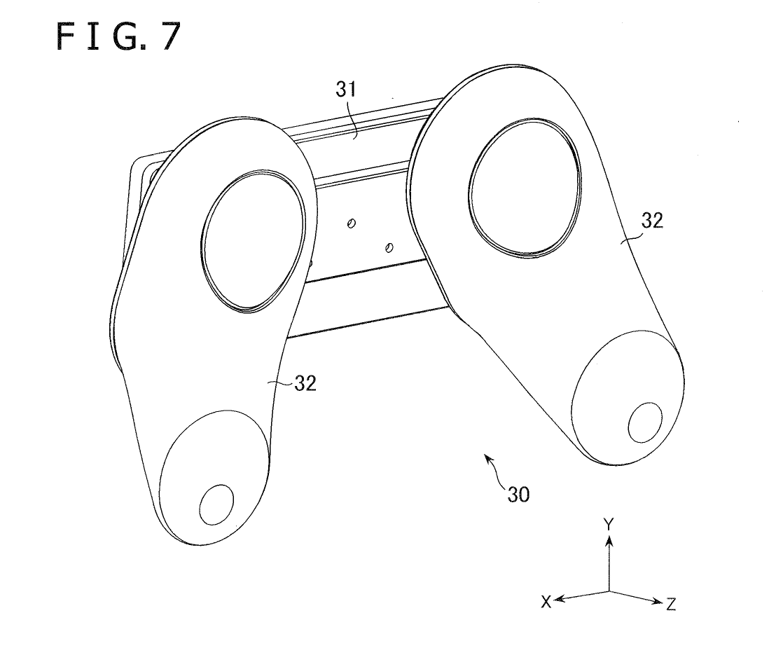

A description will be given next of a grip unit 30 as a specific example of a back-fitted attachment. FIGS. 6 and 7 are perspective views illustrating the appearance of the grip unit 30. FIG. 6 illustrates the grip unit 30 as seen from the side of the front face, and FIG. 7 illustrates the grip unit 30 as seen from the side of the back face.

As illustrated in FIG. 6, two protrusion portions 31a and a lug 31b are provided on the front face side of a fitting section 31 of the grip unit 30. Here, the tips of the protrusion portions 31a spread out in the x-axis direction. When each of the two protrusion portions 31a is inserted into the wide portion of one of the vertical holes 14a on the back face of the core unit 10, and then the grip unit 30 is slid in the y-axis direction, the protrusion portions 31a move to the narrow portions of the vertical holes 14a and will no longer slip out of the vertical holes 14a. At the same time, the lug 31b engages with the lug accommodating section 14b, thus fastening the grip unit 30 to the core unit 10. At this time, the front face of the grip unit 30 covers the back face 10c of the core unit 10.

Two gripping sections 32 are connected on the side of the back face of the fitting section 31. The user can hold and operate the controller device 1 with more ease by fitting the grip unit 30 to the core unit 10 and gripping the gripping sections 32 with his or her hands.

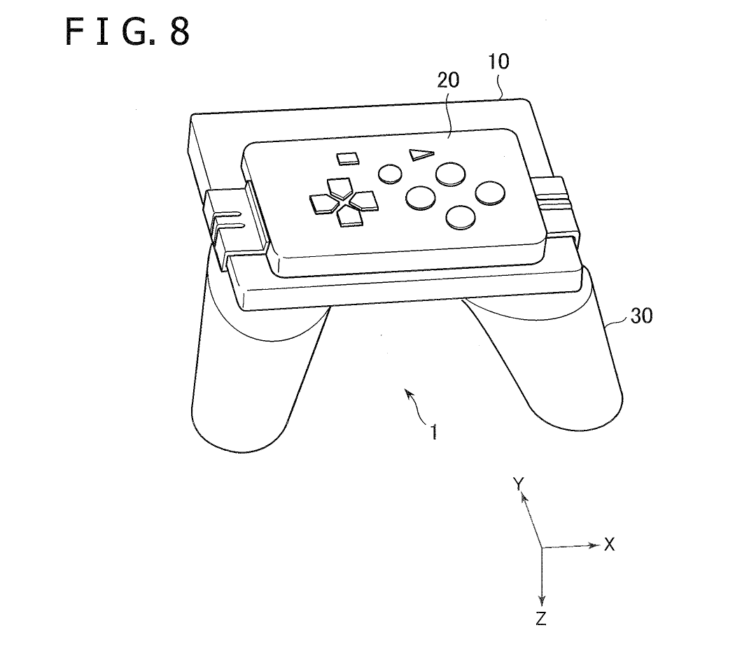

It should be noted that attachments that are fitted to different positions of the core unit 10 can be fitted to the core unit 10 at the same time. That is, the user can use the controller device 1 with a front-fitted attachment fitted on the side of the front face of the core unit 10 and a back-fitted attachment fitted on the side of the back face of the core unit 10. FIG. 8 is a perspective view illustrating the controller device 1 with the first button unit 20 and grip unit 30 that have been described above fitted to the core unit 10 at the same time. By fitting an attachment having an operating member to one face of the core unit 10 and another attachment having gripping sections to the face on the opposite side of the one face, the user can operate the buttons such as the action buttons 22 and direction indicating buttons 23 while holding the gripping sections 32. The nature of operation performed on each of the buttons by the user is detected by the touch sensor 11 on the core unit 10 and transmitted to the information processor 2.

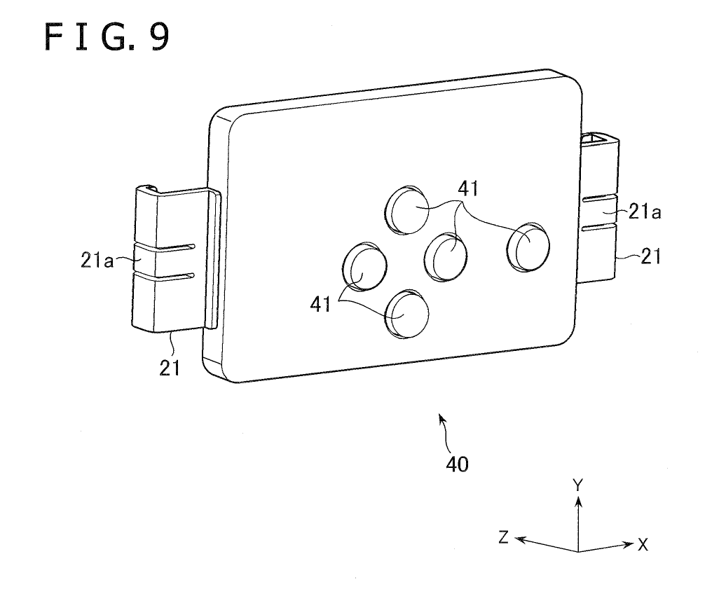

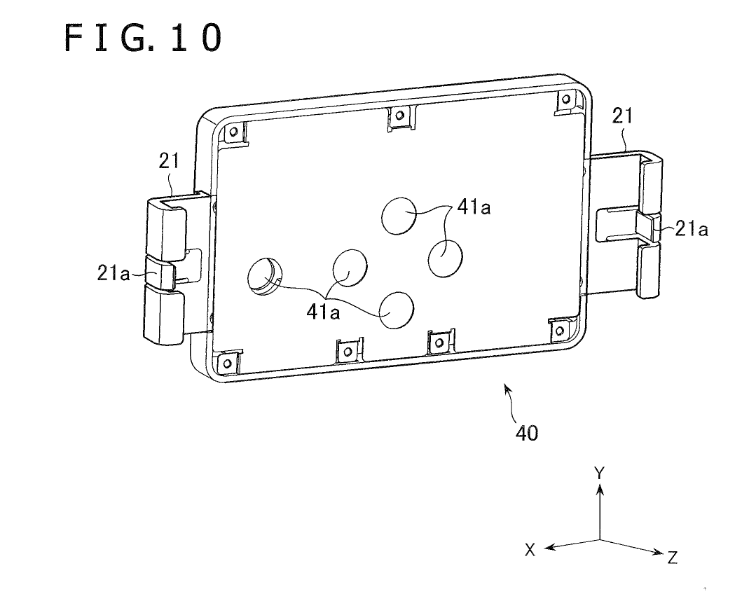

A description will be given next of a second button unit 40 as another example of a front-fitted attachment with reference to FIGS. 9 and 10.

A plurality of buttons 41 are provided on the front face of the second button unit 40 as with the first button unit 20. These buttons may have the same structure as those provided on the first button unit 20. Further, the holding sections 21, each having the lug 21a, are provided on the second button unit 40 as with the first button unit 20. The second button unit 40 is fitted to the core unit 20 with these lugs 21a.

Here, although the first and second button units 20 and 40 have buttons with the same structure, these buttons are arranged differently. Therefore, when the user operates each of the buttons 41 with the second button unit 40 fitted, the position at which a lower end 41a of the operated button 41 on the side of the back face comes into contact with the touch sensor 11 of the core unit 10 differs from that when the first button unit 20 is fitted.

The core unit 10 includes means of acquiring identification information used to identify the type of attachment fitted to itself. The information processor 2 can identify which operating member of which type of attachment has been operated by combining this identification information with the detection result of the touch sensor 11.

A description will be given here of a specific method used by the core unit 10 to acquire identification information of an attachment. A front-fitted attachment is fitted to the core unit 10 in such a manner as to cover the touch sensor 11. Therefore, the touch sensor 11 can be used to acquire identification information. In this case, we assume that a plurality of types of front-fitted attachments have one or a plurality of protrusions arranged in different patterns. This or these protrusions project toward the side of the back face of the front-fitted attachment in such a manner as to come into contact with the touch sensor 11 with the attachment fitted to the core unit 10. As the touch sensor 11 detects the contact position or positions of the one or plurality of protrusions, the core unit 10 can identify the type of the front-fitted attachment. That is, information about the contact position or positions of the protrusion or protrusions detected by the touch sensor 11 serves as identification information of the attachment.

Alternatively, the core unit 10 may optically acquire identification information marked on the face of each attachment. For example, an identification tag is affixed to a predetermined position on each attachment so that the core unit 10 reads information marked on this identification tag with an optical sensor. This allows the core unit 10 to determine the type of attachment to which the tag is affixed. It should be noted that this method is applicable to all types of attachments, namely, front-, back- and side-fitted attachments.

Still alternatively, each attachment may include an RFID tag such as IC tag having identification information of its own stored therein, and the core unit 10 may incorporate a tag reader adapted to read information stored in this RFID tag. As a result, the core unit 10 can identify the type of attachment fitted thereto by reading information stored in the RFID tag provided nearby using the tag reader. This method is also applicable to attachments fitted to different positions.

It should be noted that although, in the description given above, the core unit 10 determines the type of attachment fitted thereto, the core unit 10 may acquire identification information and transmit the acquired identification information to the information processor 2 so that the information processor 2 determines the attachment type using the identification information received from the core unit 10.

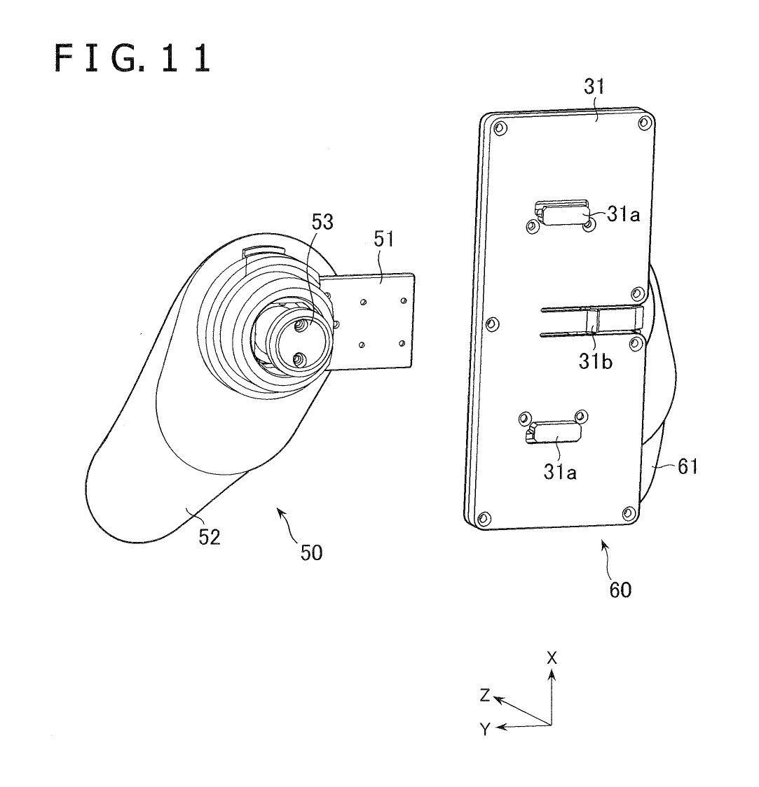

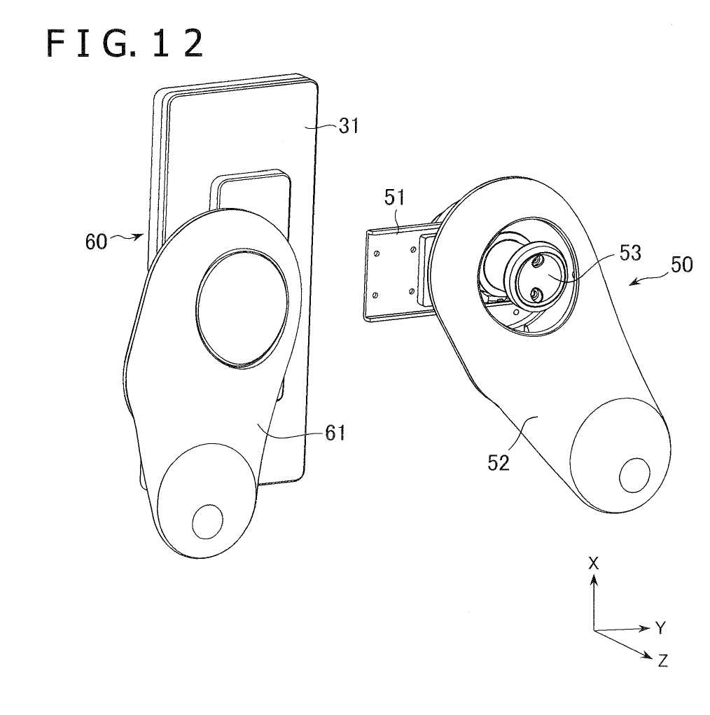

A description will be given next of examples of side- and back-fitted attachments that are used as a set with reference to FIGS. 11 and 12. These figures illustrate perspective views of a three-dimensional operation input unit 50 and auxiliary grip unit 60 that are likely fitted to the core unit 10 at the same time.

The three-dimensional operation input unit 50 is an example of a side-fitted attachment and includes an insertion section 51 used for fitting to the core unit 50, and left-hand gripping section 52 and analog stick 53. The three-dimensional operation input unit 50 is fitted to the core unit 10 by inserting the insertion section 51 into the insertion slot 13a from above the core unit 10. With the three-dimensional operation input unit 50 fitted to the core unit 10, the user operates the analog stick 53 while gripping the left-hand gripping section 52 with his or her left hand. The analog stick 53 can be operated not only by being tilted vertically and horizontally (in the x- and y-axis directions) but also by being pushed in in the longitudinal direction (z-axis direction). This allows the user to indicate a desired direction in a three-dimensional space. The three-dimensional operation input unit 50 transmits a signal indicating the nature of operation performed by the user on the analog stick 53 directly to the information processor 2 independently of the core unit 10.

The auxiliary grip unit 60 includes the fitting section 31 having the protrusion portions 31a and lug 31b as does the grip unit 30. The auxiliary grip unit 60 is fitted to the back face of the core unit 10 via the fitting section 31. Further, the auxiliary grip unit 60 includes a right-hand gripping section 61 to be gripped by the user with his or her right hand.

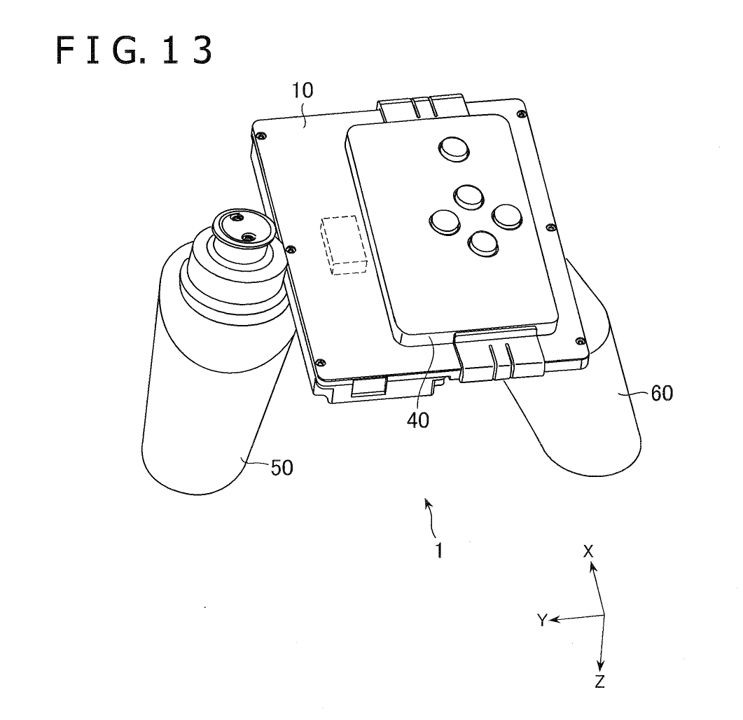

FIG. 13 illustrates the controller device 1 with the second button unit 40 fitted to the front face 10a of the core unit 10, the auxiliary grip unit 60 fitted to the back face 10c, and the three-dimensional operation input unit 50 fitted to the side face 10b. Thus, three attachments are fitted at the same time to the core unit 10 respectively via the first to third fitting mechanisms. Further, as illustrated in FIG. 13, the left-hand gripping section 52 of the three-dimensional operation input unit 50 and the right-hand gripping section 61 of the auxiliary grip unit are fitted in orientations different by 90 degrees from those of the gripping sections 32 of the grip unit 30 relative to the core unit 10. Therefore, when the three-dimensional operation input unit 50 and auxiliary grip unit 60 are fitted to the core unit 10, the user grips the controller device 1 in an orientation different from that when the grip unit 30 is fitted.

As described above, the user can make an operation input by gripping the controller device 1 in a variety of orientations in accordance with not only the orientations of the operating members and gripping sections of the attachments but also the directions in which the attachments are fitted to the core unit 10. Here, the information processor 2 can identify in which orientation the user is holding the controller device 1 by using the detection result of the posture detection sensor 15 incorporated in the core unit 10. For this reason, interpreting the direction of operation performed by the user on an operating member using such orientation information provides the same operation feel in operating the operating member irrespective of in which direction the user holds the controller device 1. For example, if it is determined based on the detection result of the posture detection sensor 15 that the user holds the core unit 10 in landscape orientation (orientation in which the x-axis direction is close to the horizontal direction and the y-axis direction is close to the perpendicular direction), the information processor 2 interprets an operation input of the analog stick 53 along the x-axis direction as indicating the horizontal direction and an operation input of the analog stick 53 along the y-axis direction as indicating the vertical direction. Conversely, if it is determined that the user holds the core unit in portrait orientation (orientation in which the x-axis direction is close to the perpendicular direction and the y-axis direction is close to the horizontal direction), the information processor 2 interprets an operation input of the analog stick 53 along the x-axis direction as indicating the vertical direction and an operation input of the analog stick 53 along the y-axis direction as indicating the horizontal direction.

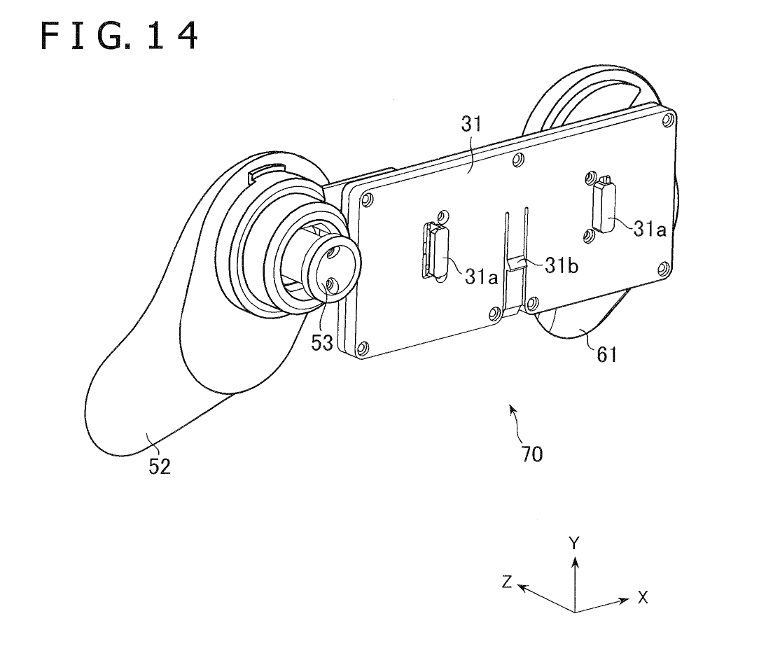

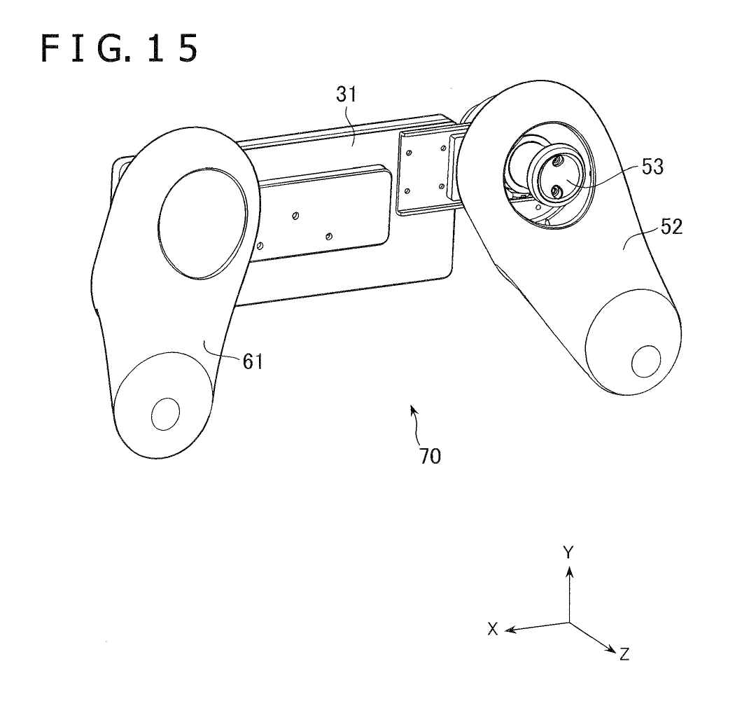

A description will be given next of an integral type three-dimensional operation input unit 70 as another example of a back-fitted attachment with reference to FIGS. 14 and 15. The integral type three-dimensional operation input unit 70 is an attachment that includes the same members as the three-dimensional operation input unit 50 and auxiliary grip unit 60 all by itself. That is, the integral type three-dimensional operation input unit 70 includes the left-hand gripping section 52, analog stick 53 and right-hand gripping section 61. Further, the integral type three-dimensional operation input unit 70 includes the fitting section 31 having the two protrusion portions 31a and lug 31b as a fitting mechanism to the core unit 10. It should be noted that when this back-fitted attachment is fitted to the core unit 10, the orientations of the gripping sections thereof relative to the core unit 10 differ by 90 degrees from those of the three-dimensional operation input unit 50 and auxiliary grip unit 60.

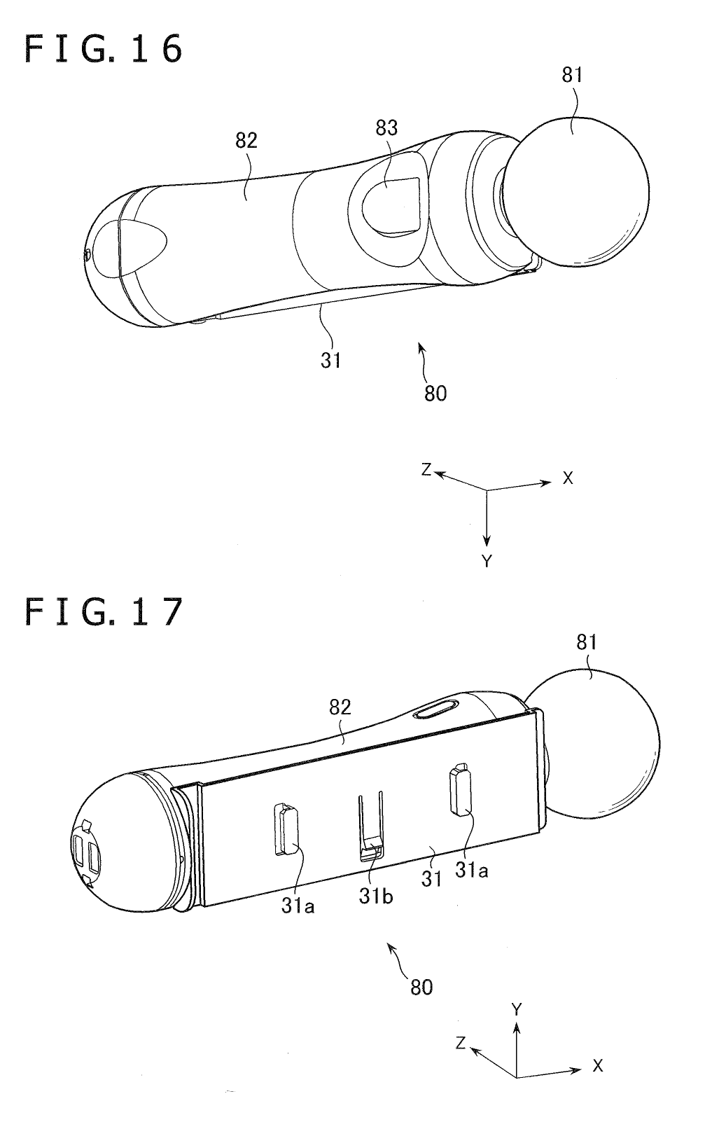

A description will be given next of a sphere unit 80 as still another example of a back-fitted attachment with reference to FIGS. 16 and 17. The sphere unit 80 includes a sphere-shaped light-emitting section 81 and cylindrical gripping section 82 with a trigger button 83 provided on the gripping section 82. Further, the fitting section 31 similar to that of the grip unit 30 is connected to the gripping section 82, with the two protrusion portions 31a and lug 31b provided on the fitting section 31. The sphere unit 80 is fitted to the back face of the core unit 10 with the protrusion portions 31a and lug 31b as are the grip unit 30 and other attachments. Further, the sphere unit 80 can directly communicate with the information processor 2 independently of the core unit 10, transmitting a signal indicating the nature of operation performed on the trigger button 83 to the information processor 2. Further, the sphere unit 80 lights up the light-emitting section 81 in response to an instruction from the information processor 2. The information processor 2 identifies the position of the controller device 1 in the real space by imaging light from this light-emitting section 81 with the imaging device 7.

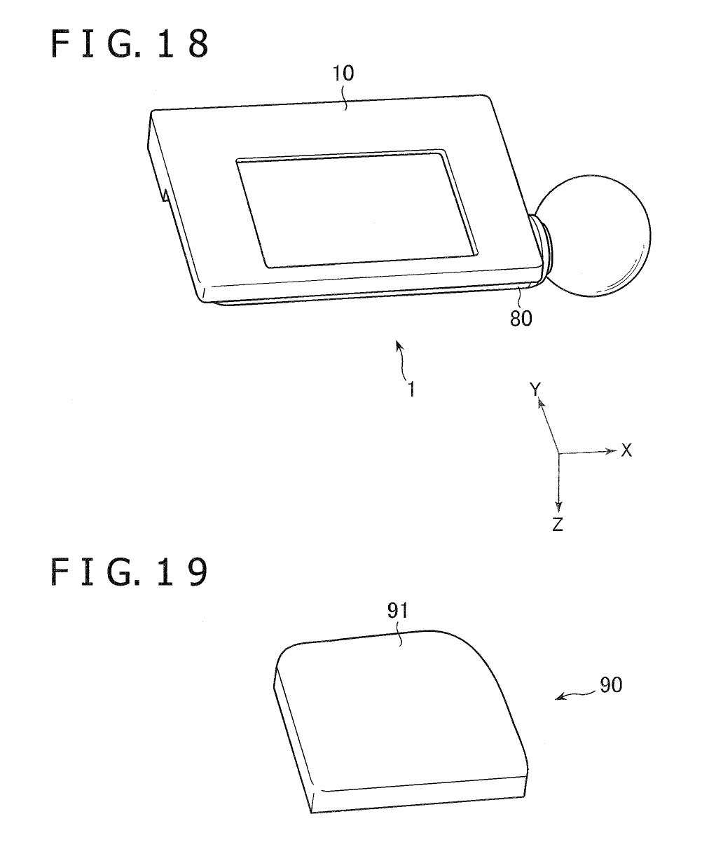

FIG. 18 is a perspective view illustrating the controller device 1 with the sphere unit 80 fitted to the core unit 10. The user can intuitively make an operation input to the information processor 2 by gripping the gripping section 82 and moving the controller device 1 to a variety of positions.

A description will be given next of a variety of attachments used to detect the nature of user operation input primarily with the touch sensor 11. These attachments are front-fitted attachments that are all fitted to the core unit 10 in such a manner as to cover the touch sensor 11 so as to detect the nature of user operation input with the touch sensor 11. Further, each of these attachments includes an operating member that can come into contact with the touch sensor 11 when fitted to the core unit 10. The manner in which the operating member comes into contact with the touch sensor 11 changes in response to a user operation. Each of these attachments detects the nature of user operation using the touch sensor 11 of the core unit 10. Therefore, there is no need to provide electrical circuitry in the attachment. It is only necessary for the attachment to include a mechanism adapted to mechanically transfer the nature of user operation to the touch sensor 11.

A description will be given below of an attachment that includes an operating member having a planar operation region sized to match the detection surface of the touch sensor 11 as an example of such an attachment. As described earlier, the touch sensor 11 is a multipoint detection sensor that is also capable of detecting the pressure, thus detecting not only simply contact of an object of some kind with a point of the detection surface but also the manner in which a soft and large object is in contact with the detection surface if such an object comes into contact therewith. For this reason, using an operating member having a planar operation region of a certain extent and of a comparable size to match the detection surface of the touch sensor 11 and formed with an elastic material provides a hitherto unknown operation feel.

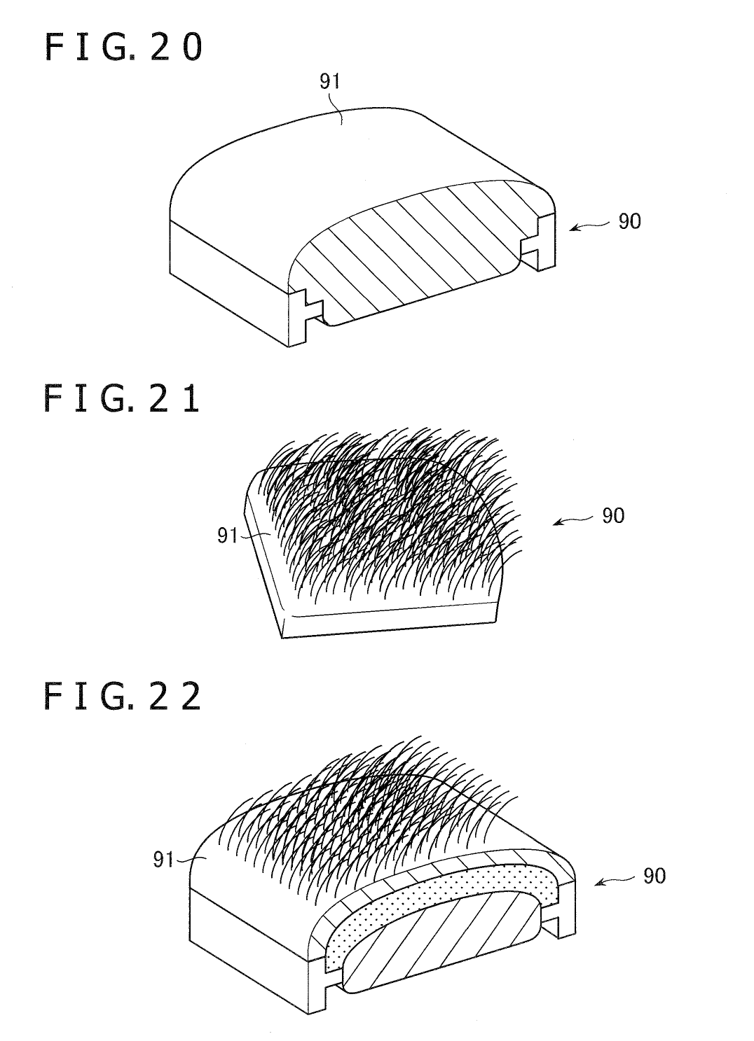

FIG. 19 is a perspective view illustrating an example of a pressing operation unit 90 that includes an operating member having such a planar operation region (hereinafter referred to as a pressing operation member 91). On the other hand, FIG. 20 is a sectional view of the pressing operation unit 90 shown in FIG. 19. It should be noted that because the fitting mechanism for a front-fitted attachment described so far may be used to fit the attachment described here to the core unit 10, the fitting mechanism is not shown in the subsequent figures.

As shown in these figures, the pressing operation member 91 penetrates the pressing operation unit 90 in the z-axis direction, being arranged to occupy approximately the entire front and back faces of the pressing operation unit 90. The pressing operation member 91 may be formed, for example, with a material such as rubber, elastomer or filler. When the user presses a finger or other object against an arbitrary position of the front face of the pressing operation member 91 from above, the applied pressure is conveyed through the pressing operation member 91, causing part of the face of the pressing operation member 91 on the side of the touch sensor 11 to be pressed against the detection surface of the touch sensor 11. At this time, the position at which the touch sensor 11 detects the pressure changes with change in the position against which the user presses the pressing operation member 91. Further, the size and shape of the area over which the touch sensor 11 detects the pressure and the magnitude of pressure detected change with change in the magnitude of force applied by the user to press the pressing operation member 91 and the manner in which the pressure is applied. Still further, the magnitude of pressure detected by the touch sensor 11 and the extent of area over which the touch sensor 11 detects contact of the pressing operation member 91 change with the difference in operation mode such as whether the user has pressed the pressing operation member 91 with one finger, with a plurality of fingers or with a palm. The information processor 2 detects approximately which part of the pressing operation member 91 has been pressed by the user with approximately how much force using the detection result of the touch sensor 11, reflecting the detection result in the information processing task the information processor 2 conducts.

FIGS. 21 and 22 are diagrams illustrating an example of another type of the pressing operation unit 90. In the example shown in these figures, the face of the pressing operation member 91 is fur. Thus, it is possible to provide the user with a group of attachments that can be operated with various tactile sensations by changing the face material of the pressing operation member 91. Further, the pressing operation member 91 may be formed by stacking a plurality of materials having different hardnesses and elasticities one on top of another as illustrated in the sectional view of FIG. 22. This provides operating members having a feel close to that of practically existing objects such as animals and skin of human.

A description will be given next of another example of an attachment that includes an operating member the manner of whose contact with the touch sensor 11 changes in response to a user operation. More specifically, a description will be given below of an example of an attachment that includes a moving operating member whose contact position with the touch sensor 11 changes in response to a user operation. Unlike the operating buttons available with the first and second button units 20 and 40 described above, not only simply whether or not this moving operating member is in contact changes in response to the presence or absence of a user operation but also the contact position with the detection surface of the touch sensor 11 moves in response to a user operation along the orientation parallel to the detection surface of the touch sensor 11. Therefore, the information processor 2 can determine the manner in which the user is moving the moving operating member and perform a processing task suitable for the motion of the operation member by acquiring information indicating the change in the contact position detected by the touch sensor 11.

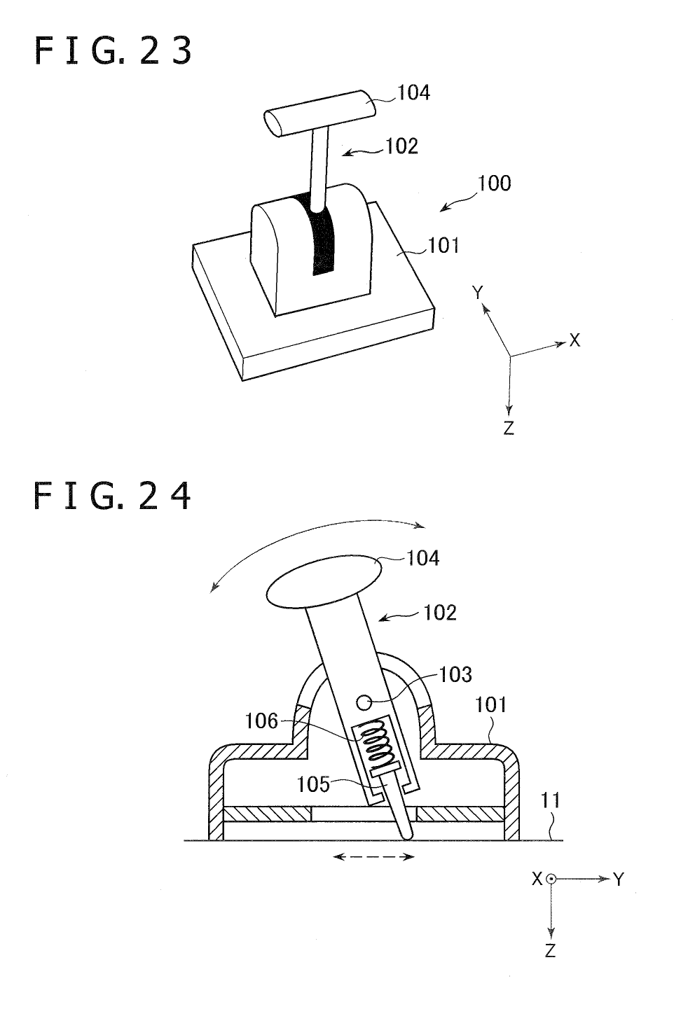

A description will be given of the structure of a throttle lever unit 100, an example of an attachment having a moving operating member, with reference to FIGS. 23 and 24. FIG. 23 is a perspective view illustrating the appearance of the throttle lever unit 100, and FIG. 24 is a sectional view illustrating the internal structure thereof. As shown in these figures, the throttle lever unit 100 includes a base 101 and lever 102. Further, the lever 102 includes a rotary shaft 103, operating target section 104, sensor contact section 105 and spring 106.

The lever 102 is arranged as a whole to penetrate the throttle lever unit 100 and rotatably fastened to the base 101 via the rotary shaft 103. The user grips the operating target section 104 of the lever 102 with a hand and operates the operating target section 104 by moving it back and forth. This operation rotates and moves the operating target section 104 around the rotary shaft 103 as shown by a solid arrow in FIG. 24. As a result of this rotary motion, the sensor contact section 105 moves along the y-axis direction on the detection surface of the touch sensor 11. Here, the spring 106 incorporated in the lever 102 applies a force in the direction of pressing the sensor contact section 105 against the touch sensor 11, thus maintaining the sensor contact section 105 in contact with the touch sensor 11. Further, the tip portion of the sensor contact section 105 moves along the direction parallel to the detection surface of the touch sensor 11 as shown by a dashed-line arrow in FIG. 24 because the vertical motion of the tip portion is cushioned by the spring 106. That is, the rotary motion of the operating target section 104 is converted into a linear motion of the tip of the sensor contact section 105 parallel to the touch sensor 11 by the action of the spring 106. As a result, when the user rotates the operating target section 104, this operation can be detected by the touch sensor 11 having a flat detection surface.

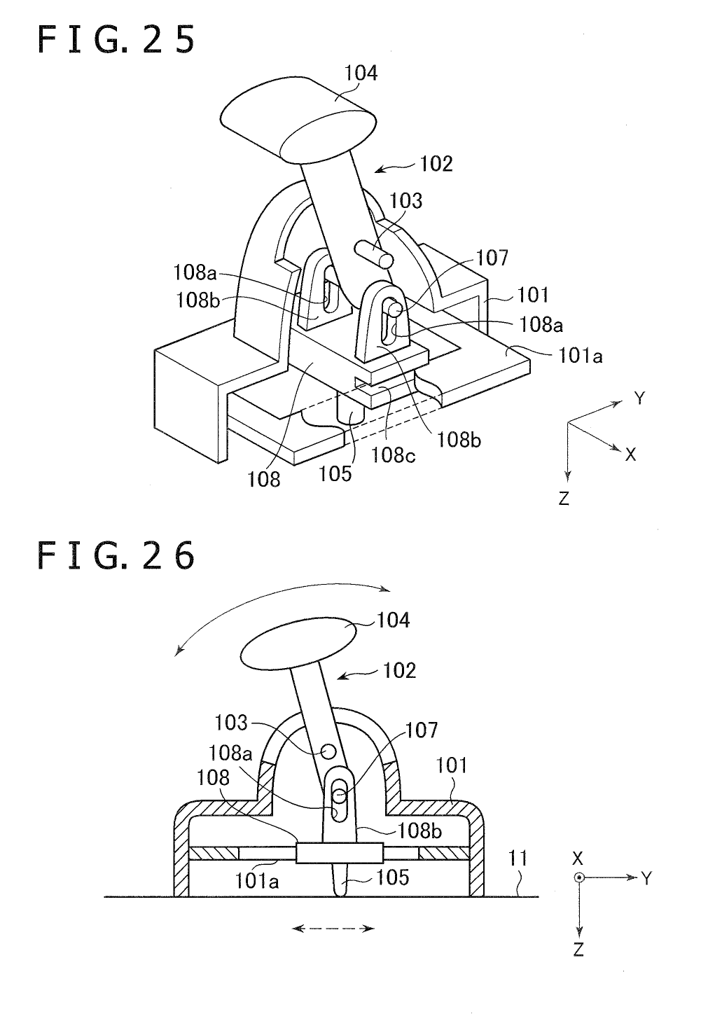

FIGS. 25 and 26 illustrate another example of internal structure of the throttle lever unit 100. In this example, the lever 102 includes the operating target section 104 and a linked operation section 108. The rotary shaft 103 and an acting section 107 are connected to the operating target section 104. The linked operation section 108 is formed as a separate piece from the operating target section 104. The sensor contact section 105 is formed to protrude from the bottom face of the linked operation section 108. The linked operation section 108 includes two upright portions 108b, each having a vertical hole 108a formed therein. Each of the two ends of the acting section 107 of the lever 102 is inserted in one of the vertical holes 108a. Further, grooves 108c are formed, one on the left and another on the right of the linked operation section 108, along the direction parallel to the detection surface of the touch sensor 11, with the end portions of a guide section 101a provided in the base 101 inserted in the grooves 108c.

When the user moves the operating target section 104 of the lever 102 back and forth, the operating target section 104 rotates around the rotary shaft 103, causing the acting section 107 to exert a force on the linked operation section 108. Here, because the end portions of the guide section 101a extending in the direction parallel to the touch sensor 11 are inserted in the grooves 108c, the linked operation section 108 moves along the direction parallel to the touch sensor 11. The motion of the acting section 107 in the direction vertical to the touch sensor 11 is cushioned by the vertical holes 108a and, therefore, is not transferred to the linked operation section 108. As a result, the rotary motion of the operating target section 104 is converted into a linear motion of the sensor contact section 105 parallel to the touch sensor 11 as in the example shown in FIG. 24.

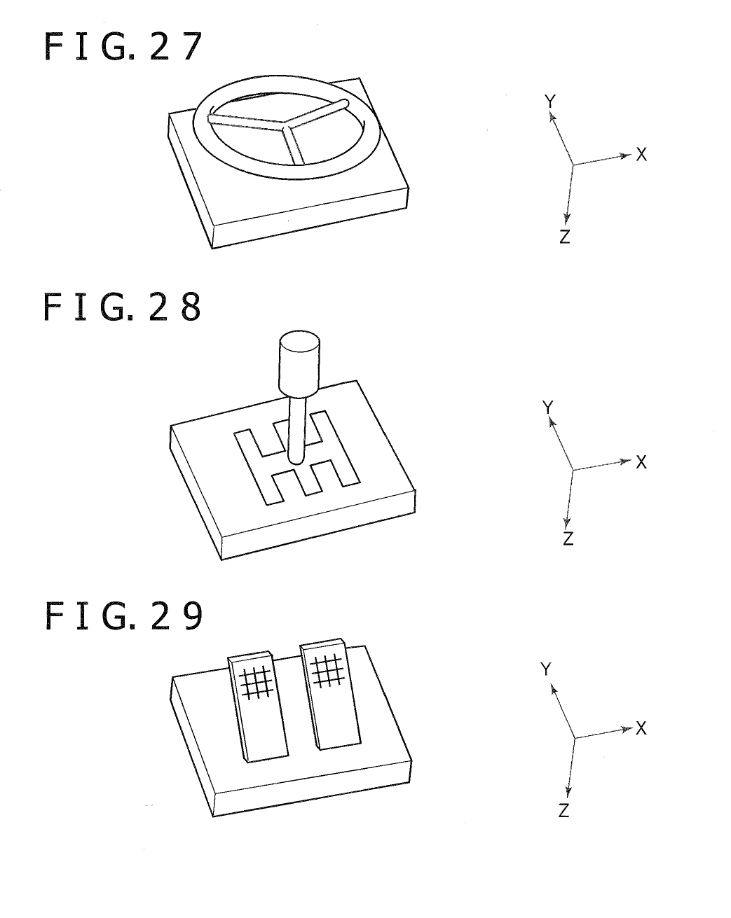

Further, a description will be given of other examples of attachments having a variety of operating members. FIGS. 27 to 29 respectively illustrate examples of attachments which have operating members imitating devices used to drive a vehicle, as does the throttle lever unit 100 shown in FIG. 23.

FIG. 27 illustrates an attachment having an operating member imitating a steering wheel. When the user turns this steering wheel, a sensor contact section (not shown) connected to this steering wheel moves over the detection surface in such a manner as to trace a circle while at the same time remaining in contact with the detection surface of the touch sensor 11. As the touch sensor 11 detects such a motion of the sensor contact section (not shown), the information processor 2 can acquire information about the extent to which and the speed with which the steering wheel is turned.

FIG. 28 illustrates an attachment having an operating member imitating a gear change lever. This attachment functions in the same manner as that shown in FIG. 27. When the user moves the gear change lever in the direction parallel to the touch sensor 11, the sensor contact section connected to the gear change lever moves over the detection surface of the touch sensor 11 in response to the user operation.

FIG. 29 illustrates an attachment having an operating member imitating an accelerator pedal and brake pedal. With this attachment, when the user steps on each of the accelerator pedal and brake pedal, the pressure with which the sensor contact section connected to each of these pedals is pressed against the touch sensor 11 changes in accordance with how much the pedal is stepped on. The information processor 2 can find out the extent to which each pedal has been stepped on by the user using the magnitude of pressure detected by the position of the touch sensor 11 associated with each of the pedals.

FIGS. 30 to 32 illustrate examples of attachments having operating members imitating musical instruments. More specifically, the attachment shown in FIG. 30 has an operating member imitating a keyboard, and the attachment shown in FIG. 31 has operating members imitating piston valves of a trumpet. These operating members include sensor contact sections adapted to come into contact with the detection surface of the touch sensor 11 in response to a pressing operation by the user as do the buttons of the first and second button units 20 and 40. On the other hand, the attachment shown in FIG. 32 includes an operating member imitating a drum. This operating member may be the same as the pressing operation member 91 shown in FIGS. 19 and 21.

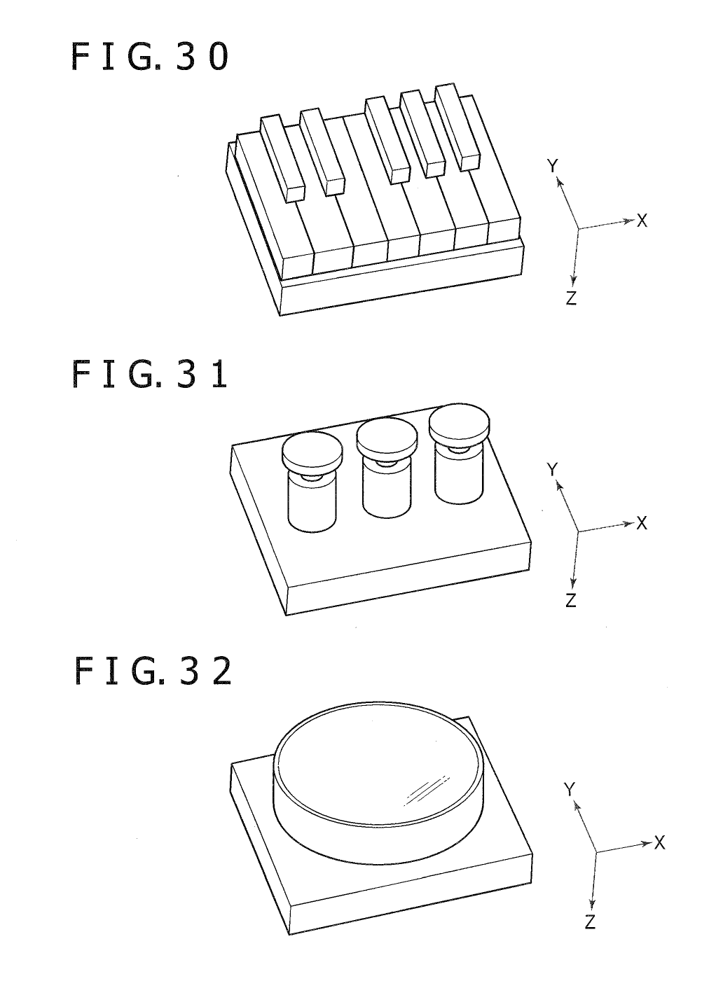

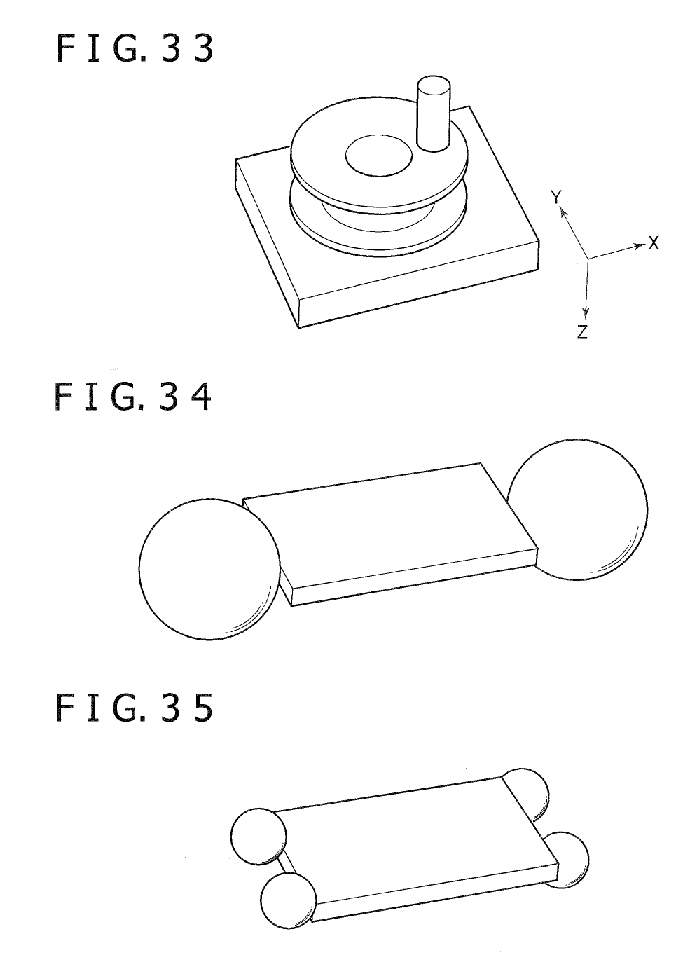

FIG. 33 illustrates an example of an attachment having an operating member imitating a reel of a fishing rod. This operating member may operate in the same manner as the operating member imitating a steering wheel shown in FIG. 27.

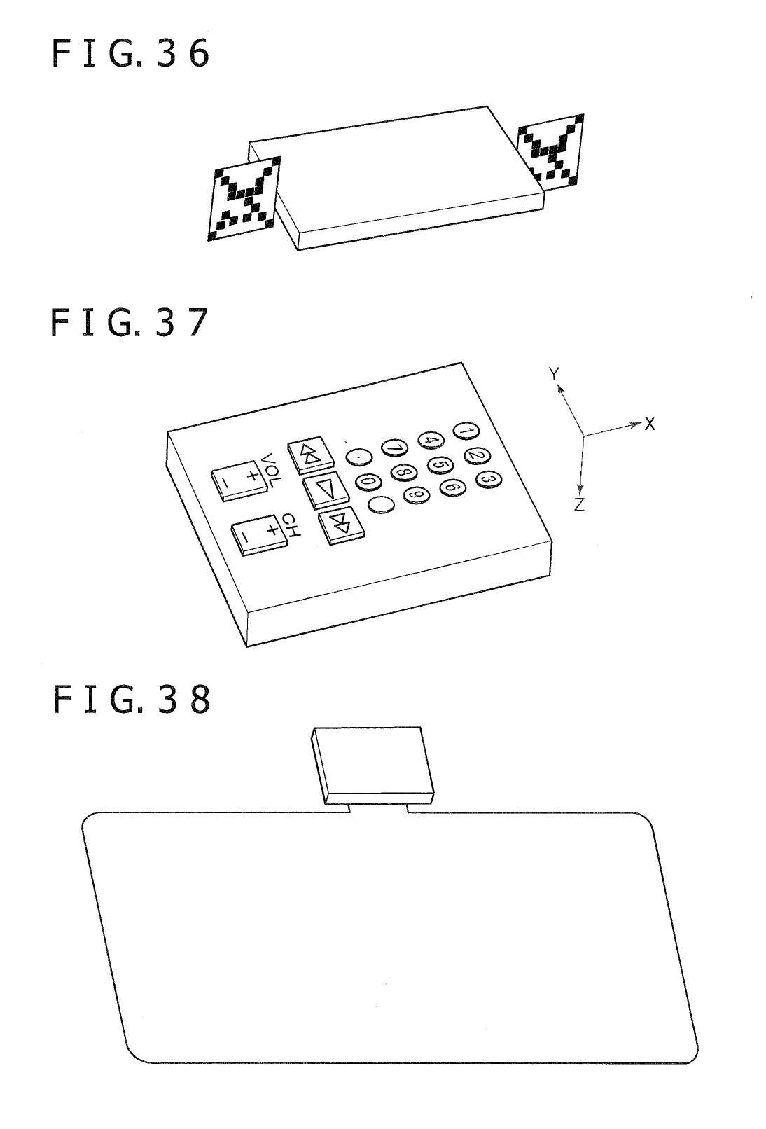

FIGS. 34 to 36 illustrate examples of attachments having members to be optically detected as does the sphere unit 80. FIGS. 34 and 35 illustrate attachments having a plurality of light-emitting sections as does the sphere unit 80. On the other hand, FIG. 36 illustrates an attachment having markers rather than light-emitting sections. These markers may represent a coded image such as two-dimensional barcode. The information processor 2 can perform a variety of processing tasks appropriate to the nature of the markers by the imaging device 7 capturing an image of the markers and the information processor 2 analyzing the coded image represented by the markers.

FIG. 37 is a diagram illustrating an example of an attachment that functions as a remote controller adapted to operate, for example, a household electric appliance. In this example, the core unit 10 has a functionality to communicate with the household electric appliance, for example, by infrared radiation. When the touch sensor 11 detects that the user has pressed one of the buttons provided on the attachment, the core unit 10 transmits an operation signal appropriate to the pressed button to the household electric appliance.

FIG. 38 illustrates an example of a mat-shaped attachment adapted to make an operation input as a result of the user stepping on it with a foot. The attachment shown in this example transmits information indicating the mat position stepped on by the user to the information processor 2.

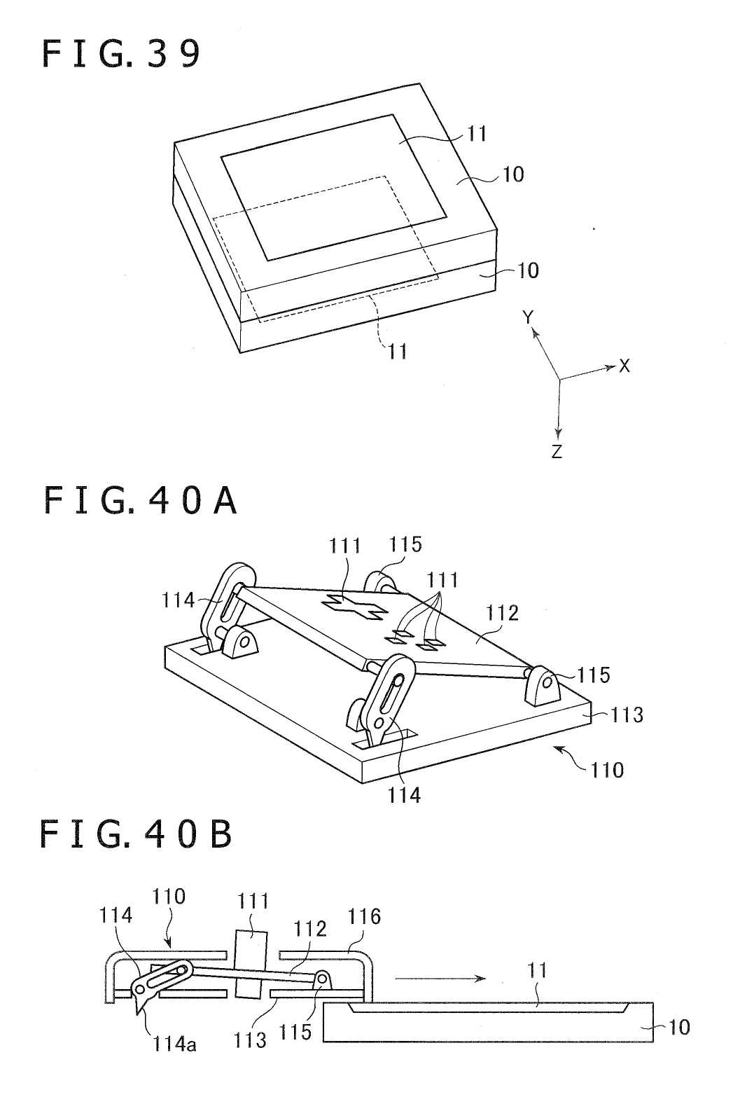

In addition to those shown above, a variety of other attachments may be fitted to the core unit 10. For example, an attachment having a touch sensor different from the touch sensor 11 may be fitted to the core unit 10. In particular, using such an attachment having a touch sensor as a back-fitted attachment provides the controller device 1 with two touch sensors, the touch sensor 11 of the core unit 10 on the front face and the touch sensor of the attachment on the back face as illustrated in FIG. 39. Alternatively, the core unit 10 itself may be fitted to the other core unit 10. In particular, configuring the fitting mechanism in such a manner that the two core units 10 can be connected back to back provides a controller device having touch sensors one on the front face and another on the back face as described above.

Further, an attachment having an external battery adapted to supply power to the core unit 10 may be fitted to the core unit 10. In this case, power supply terminals are provided where the core unit 10 comes into contact with the attachment so that the attachment is fitted via these terminals.

Still further, in the above description, the attachments other than the front-fitted attachments having an operating member adapted to come into contact with the touch sensor 11 either do not have any operating member or directly transmit, to the information processor 2, information indicating the nature of operation made to the operating members of the attachments. However, the present invention is not limited thereto, and each attachment may include, for example, a connector that permits connection with the core unit 10 for communication so as to transmit a signal indicating the nature of operation made to the operating member of the attachment by the user to the core unit 10 via this connector. In this case, the core unit 10 transmits the signal indicating the nature of operation received from its own attachment to the information processor 2 together with the detection result of the touch sensor 11.

Still further, in the above description, the controller device 1 is used exclusively for the user to make an input. In addition to this, however, the controller device 1 may have a functionality to produce an output to the user. More specifically, the core unit 10 or an attachment fitted to the core unit 10 may include a vibration unit such as motor or actuator, a speaker adapted to produce audio, a lamp for presenting information to the user and so on. Further, a mechanism may be provided on the touch sensor 11 or the operating member or gripping section of the attachment to provide force feedback to a user operation.

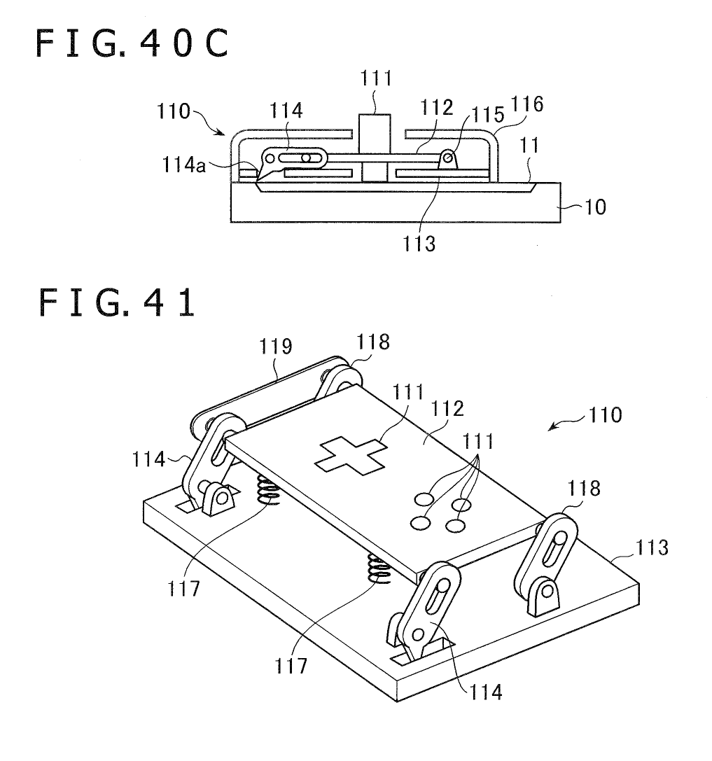

A description will be given next of an example of an operating member drive mechanism adapted to avoid contact of an operating member with the touch sensor 11 during fitting of an attachment having the operating member that likely comes into contact with the touch sensor 11 to the core unit 10. FIGS. 40A to 40C are diagrams illustrating an example of such an operating member drive mechanism. FIG. 40A is a perspective view of an attachment 110 having an operating member 111. FIG. 40B is a sectional view illustrating that the fitting of the attachment 110 to the core unit 10 is in progress. FIG. 40C is a sectional view illustrating that the fitting of the attachment 110 to the core unit 10 is complete. It should be noted that the attachment 110 is devoid of a cover 116 to show the internal structure thereof in FIG. 40A.

When the attachment 110 is not fitted to the core unit 10, a plate 112 having the operating member 111 is connected to a base 113 of the attachment 110 by a fulcrum 115 and is pushed upward by a spring (not shown) so that it is at slightly away from the base 113. Further, the plate 112 is supported by a lever 114. A lug 114a is provided on the lower end of the lever 114 and protrudes downward from the bottom face of the base 113. The attachment 110 is fitted to the core unit 10 by sliding the attachment 110 from one end of the core unit 10 in the direction shown by the arrow as shown in FIG. 40B. At this time, the plate 112 is floated from the base 113, thus maintaining the lower end of the operating member 111 away from the touch sensor 11. Here, when the attachment 110 is moved where it entirely overlaps the core unit 10, the lug 114a is pressed by the core unit 10, thus rotating the lever 114 and pushing the plate 112 downward. Thanks to this action of the lever 114, when the fitting of the attachment 110 to the core unit 10 is complete, the plate 112 moves in the direction parallel to the touch sensor 11, thus bringing the lower end of the operating member 111 into contact with the detection surface of the touch sensor 11. That is, the operating member 111 remains out of contact with the touch sensor 11 until the fitting of the attachment 110 is complete, and the operating member 111 comes into contact with the touch sensor 11 when the fitting of the attachment 110 is complete.

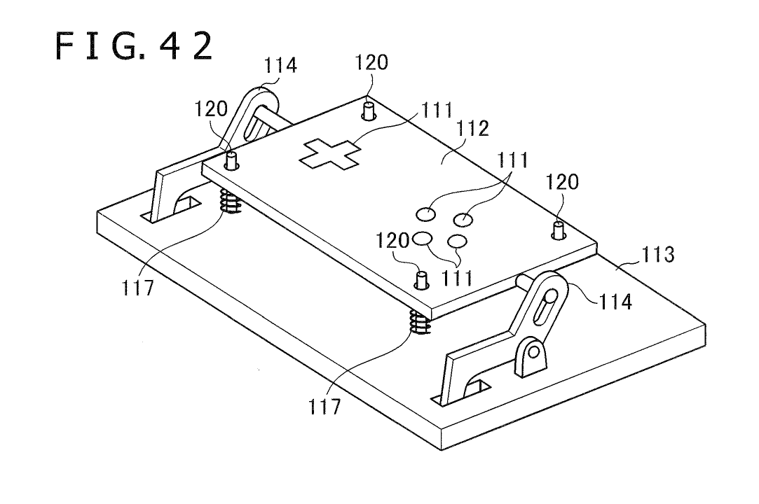

FIGS. 41 and 42 are diagrams respectively illustrating other examples of operating member drive mechanisms. In the example shown in FIG. 41, the plate 112 is supported at its four corners by a total of four levers, the two levers 114 each having a lug and two levers 118 each having no lug, and is pushed upward by a spring 117. As a result, when the attachment 110 is not fitted to the core unit 10, the plate 112 is maintained approximately parallel to and away from the base 113. When the core unit 10 is fitted to the attachment 110, the lugs provided on the two levers 114 are pressed by the core unit 10, thus rotating the levers 114, as in the case of the example shown in FIGS. 40A to 40C. At this time, the rotation of the levers 114 is also transferred to the levers 118 having no lugs by a parallel link 119, rotating all the four levers and pushing down the plate 112 toward the touch sensor 11. This brings the operating member 111 provided on the plate 112 into contact with the touch sensor 11.

In the example shown in FIG. 42, the plate 112 is supported at its four corners by four guide pins 120 in such a manner as to move only vertically. Further, the spring 117 is fitted to part of each of the guide pins 120. The plate 112 is pushed upward by the action of these springs 117. When this attachment 110 is fitted to the core unit 10, the lugs provided at the tips of the levers 114 are pressed by the core unit 10, thus rotating the levers 114 and pushing down the plate 112 in the same manner as in the examples described so far. At this time, the plate 112 moves along the guide pins 120 in the direction perpendicular to the touch sensor 11. This brings the operating member 111 provided on the plate 112 into contact with the touch sensor 11.

Using the above operating member drive mechanisms allows to avoid contact of an operating member with the core unit 10 during fitting of an attachment such as the pressing operation unit 90 or throttle lever unit 100 having an operating member arranged to be in contact with the touch sensor 11 while the user is not operating the operating member to the core unit 10, permitting smooth fitting of the attachment to the core unit 10. It should be noted that the structures of the operating member drive mechanisms are merely illustrative, and that the operating member may be kept out of contact with the touch sensor 11 during fitting of the attachment by other method. For example, although, in the description given above, the plate 112 is maintained away from the base 113 by the action of the springs, elastic members other than springs may also be used.

1. A controller device comprising:
a core unit having a touch sensor arranged on one face thereof; and
an attachment fitted to the core unit in such a manner as to cover the touch sensor, the attachment having an operating member that comes into contact with the touch sensor when fitted to the core unit, and the manner in which the operating member comes into contact with the touch sensor changes in response to a user operation.

2. The controller device of claim 1, wherein the contact position of the operating member with the touch sensor moves in response to a user operation in a direction parallel to the detection surface of the touch sensor.

3. The controller device of claim 1, wherein the operating member has a planar operation region sized to match the detection surface of the touch sensor so that if the user presses any position of the operation region, the manner in which the operating member comes into contact with the position of the touch sensor matching the pressed position changes.

4. The controller device of claim 3, wherein:
the operating member is configured so that at least either the pressure applied to the touch sensor or the area of contact with the touch sensor changes in accordance with the intensity with which the operation region is pressed, and
the touch sensor detects at least either the pressure applied by the operating member to the detection surface or the area of contact of the operating member.

5. The controller device of claim 1, wherein:
the operating member is arranged to be in contact with the detection surface of the touch sensor with the attachment fitted to the core unit even while the user operation does not take place, and
the attachment further includes a mechanism adapted to maintain the operating member away from the detection surface of the touch sensor until the fitting of the attachment to the core unit is complete and move the operating member to the position where the operating member comes into contact with the detection surface of the touch sensor when the fitting of the attachment to the core unit is complete.

6. A core unit of a controller device used by fitting an attachment having an operating member, the core unit comprising:
a touch sensor; and
a fitting mechanism used to fit the attachment where at least part of the touch sensor is covered;
wherein the operating member is capable of coming into contact with the touch sensor with the attachment fitted to the core unit; and
wherein the touch sensor detects a change in a manner in which the operating member comes into contact with the touch sensor in response to a user operation.

7. The controller device of claim 1, wherein:
the core unit includes first and second faces; and
the attachment includes: (i) a first attachment fitted to the core unit in such a manner as to cover at least part of the first face; and (ii) a second attachment fitted to the core unit in such a manner as to cover at least part of the second face.

8. The controller device of claim 7, wherein at least one of the first attachment and the second attachment includes a gripping section gripped by the user with a hand.

9. The controller device of claim 7, wherein the second face is opposed to the first face.

10. The controller device of claim 7, wherein the core unit further includes a third face, and the controller device further comprises a third attachment fitted to the core unit in such a manner as to cover at least part of the third face.

11. The core unit of claim 6, further comprising:
a first face;
a second face;
a first fitting mechanism used to fit any one of a plurality types of first attachments where at least part of the first face is covered; and
a second fitting mechanism used to fit any one of a plurality types of second attachments where at least part of the second face is covered.

12. An information processing system comprising:
a controller device; and
an information processor,
wherein the controller device includes:
a core unit having a first face and a second face,
a first attachment fitted to the core unit in such a manner as to cover at least part of the first face, and
a second attachment fitted to the core unit in such a manner as to cover at least part of the second face, and
wherein the information processor receives, from the controller device, an operation signal indicating a nature of a user operation performed on the controller device so as to perform information processing in accordance with a received operation signal.

13. The information processing system of claim 12, wherein
at least either the first attachment or the second attachment includes a gripping section gripped by the user with a hand,
the core unit includes a posture detection sensor, and
the information processor identifies the orientation in which the user grips the gripping section using the detection result of the posture detection sensor.

14. The information processing system of claim 12, wherein
the core unit includes means of acquiring identification information used to identify the types of the first attachment and the second attachment, and
the information processor identifies each of the first attachment and the second attachment using the identification information acquired by the core unit.

15. The information processing system of claim 14, wherein
a touch sensor is provided on the first face,
the first attachment is fitted to the core unit in such a manner as to cover the touch sensor and includes a contact member adapted to come into contact with a predetermined position of the touch sensor when the first attachment is fitted to the core unit, and
the information processor identifies the type of the first attachment using information about the position of the touch sensor with which the contact member comes into contact.
